(19) United States
(12) Patent Application Publication
(10) Pub. No.: US 2021/0060505 A1
(43) Pub. Date: Mar. 4, 2021

(54) STIRRING METHOD AND STIRRING SYSTEM

(71) Applicant: ACTLAS INC., Yokote-shi (JP)

(72) Inventor: Shin Sanada, Yokote-shi (JP)

(73) Assignee: ACTLAS INC., Yokote-shi (JP)

(21) Appl. No.: 16/808,863

(22) Filed: Mar. 4, 2020

(30) Foreign Application Priority Data
Aug. 30, 2019 (JP) 2019-157779

(51) Int. Cl. B01F 11/02; G01N 1/38; B01L 9/00

(52) U.S. Cl. CPC B01F 11/0266; G01N 1/38; B01L 9/00; B01L 2300/0809; B01F 2215/0037; G01N 2001/386; B01L 2300/0609; B01F 2215/0454

(57) ABSTRACT

A stirring system includes a vibration device configured to generate vertical vibration and a holder configured to hold liquid having a free surface and receive the vertical vibration from the vibration device. The stirring system further includes processing circuitry configured to generate a Faraday surface wave on the free surface of the liquid to stir the liquid by controlling at least one of an amplitude and a frequency of the vertical vibration.

### CROSS REFERENCE TO RELATED APPLICATION

This application claims priority to Japanese Patent Application No. 2019-157779 filed on Aug. 30, 2019, which is hereby incorporated by reference herein in its entity.

### BACKGROUND

### Field

The present disclosure relates to a stirring method and a stirring system for stirring an object of stirring, more particularly to a technique that stirs a minute amount of chemical solution in a desirable manner.

### Description of Related Art

In the fields of medicine and biotechnology, techniques have been proposed for stirring a minute amount, such as several μl to several ml, of chemical solution to promote the reaction of a reagent. A device such as a shaker can be used to agitate and thus stir a liquid of a relatively large amount. However, with a minute amount of reagent, the surface tension dominates over convection, hindering stirring and mixing. Further, scattering of the chemical solution and damage to the object of stirring should be avoided. The influence of a change in the temperature also needs to be taken into consideration. Furthermore, the need for non-contact stirring to prevent contamination makes the stirring in the field of medicine and biotechnology extremely difficult.

Examples of known techniques to stir a chemical solution of a minute amount of several pi include a technique using ultrasound, a technique that excites liquid surface wave resonance with a laminated piezoelectric actuator, and an electric field stirring technique that applies a high voltage to a chemical solution.

When ultrasound is used to stir an object, the object is subjected to ultrasound of 20 to 40 kHz to promote the movement of molecules and thus achieve stirring. However, ultrasound produces cavitation, which increases the temperature of the liquid and changes the temperature of the object of stirring. The cavitation can also cause scattering or damage of the object of stirring.

Technical Document 1 describes inner flow control of micro-droplets that generates vibration using a piezoelectric element and changes the frequency of the vibration to stir droplets of about 5 μl by the resonance of the surface tension waves of the droplet.

Technical Document 2 describes a non-contact electric field stirring technique that stirs a chemical solution of about 150 μl by applying a periodic square-wave voltage to the electrodes placed above and below the chemical solution to excite the water molecules.

Technical Document 1: Matsuzawa, Hiroki et al., An Ultra Precision Production System Organized by Multiple Micro Robots (78th Report: Micro drop inner flow control based on surface tension resonator), Proceedings of Autumn Meeting of the Japan Society of Precision Engineering, 2003, 567.

Technical Document 2: Nakamura, Ryuta et al., Development of Electric Field Non-Contact Stirring Technique (E.N.S.) for Fine Particles Applied Abrasive Control Technique with AC Electric Field, Journal of the Japan Society for Precision Engineering, Vol. 80 No. 9 2014.

In recent cancer treatments, to perform surgery with minimal invasion and burden, cytodiagnosis is performed during the surgery to determine the ablation region according to the progress of the cancer. To this end, a sample is prepared immediately from the cells obtained during the surgery and is subjected to a pathological diagnosis. The course of the surgery is determined based on the result of the diagnosis.

The current intraoperative rapid pathological diagnosis uses the hematoxylin eosin staining (HE staining), which can stain a sample within 5 minutes. The hematoxylin stains cell nuclei blue, and eosin stains other structures pink. However, small remnants of cancer or lymph node micrometastasis can be overlooked with the HE staining. To perform limited resection without overlooking remnants of cancer or lymph node metastasis, immunostaining is required. However, the conventional immunostaining method takes at least two hours. A technique is needed to expedite immunostaining, and shorting of time requires rapid stirring.

Immunostaining involves stirring of a minute amount of chemical solution spreading over a relatively large area. The conventional stirring methods described above cannot efficiently stir a chemical solution in such a state.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, a stirring method is provided that includes: holding liquid having a free surface with a holder; applying vertical vibration to the holder with a vibration device; and generating a Faraday surface wave on the free surface of the liquid to stir the liquid by controlling at least one of an amplitude and a frequency of the vertical vibration.

In another general aspect, a stirring system is provided that includes a vibration device configured to generate vertical vibration and a holder configured to hold liquid having a free surface and receive the vertical vibration from the vibration device. The stirring system further includes processing circuitry configured to generate a Faraday surface wave on the free surface of the liquid to stir the liquid by controlling at least one of an amplitude and a frequency of the vertical vibration.

Other features and aspects will be apparent from the following detailed description, the drawings, and the claims.

### BRIEF DESCRIPTION OF THE DRAWINGS

FIG. 1 is a perspective view of a stirring device of the present embodiment.

FIG. 2 is a schematic view of a stirring system including the stirring device of FIG. 1.

FIG. 3 is a perspective view of a vibration device of the stirring device of FIG. 1.

FIG. 4 is a front view of the vibration device of FIG. 3.

FIGS. 5A to 5C are diagrams illustrating a honeycomb link member of the vibration device of FIG. 3.

FIG. 6A is a diagram illustrating voltage application to a piezo element from a piezo driver in the vibration device of FIG. 3.

FIG. 6B is a diagram illustrating the voltage applied to the piezo element.

FIG. 7 is a front view of honeycomb link members according to another embodiment.

FIGS. 8A to 8D are diagrams illustrating the principle of generation of a Faraday surface wave.

FIG. 9 is a graph showing the relationship between frequency and amplitude in the stirring system of FIG. 2.

FIG. 10 is a graph showing the relationship between frequency and amplitude at each voltage in the stirring system of FIG. 2.

FIG. 11 is a graph showing the relationship between voltage and amplitude at each frequency in the stirring system of FIG. 2.

FIG. 12 is a table showing the relationship between frequency, amplitude, and voltage in the stirring system of FIG. 2.

FIG. 13 is a graph showing the relationship between frequency, amplitude, and type of a Faraday surface wave in the stirring system of FIG. 2.

FIG. 14A is a schematic view showing a Faraday surface wave in a state of a standing wave.

FIG. 14B is a schematic view showing a Faraday surface wave in a state of spatiotemporal modulation.

FIG. 14C is a schematic view showing a Faraday surface wave in a state of chaos.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

One embodiment of a stirring system 1 and a stirring method using this stirring system 1 are now described.

The present embodiment rapidly stirs a minute amount of chemical solution, which may be used for immunostaining, regardless of a strong influence of surface tension, without touching or scattering the solution, altering the quality of the solution due to heat or vibration, or creating an electric or magnetic field.

<Stirring System 1>

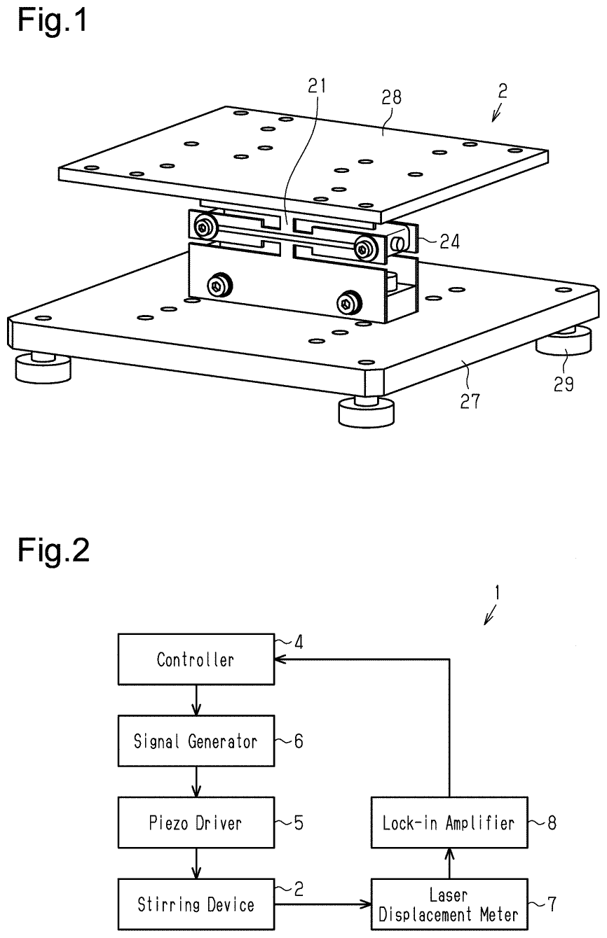

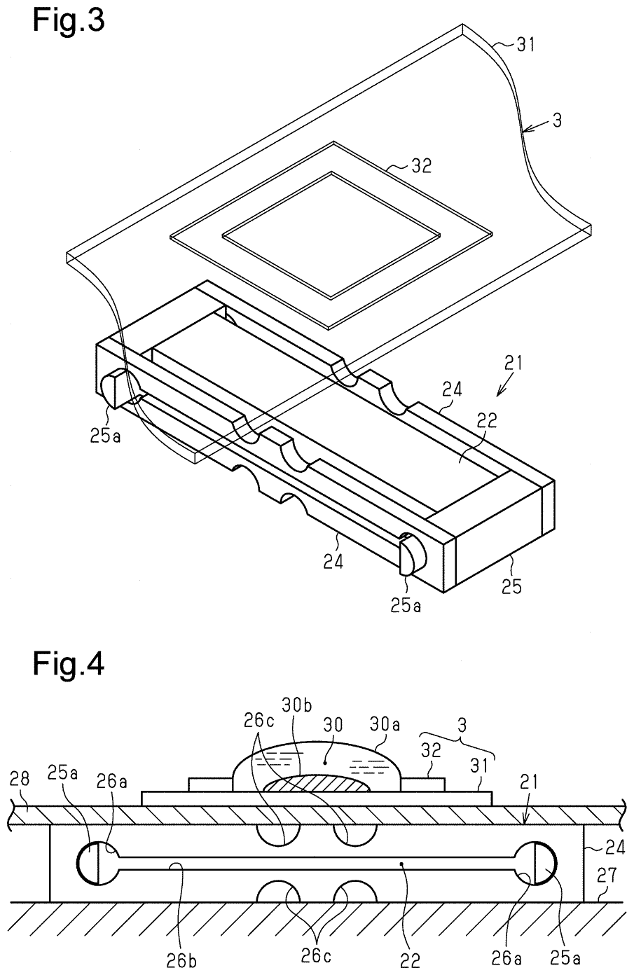

As shown in FIG. 1, the stirring system 1 has a stirring device 2 including a stage 28, on which a holder 3 (see FIGS. 3 and 4) is mounted, and a vibration device 21, which is configured to generate vertical vibration.

As shown in FIG. 2, the stirring system 1 also includes a controller 4, which controls the amplitude and frequency of the vertical vibration generated by the vibration device 21. The controller 4 may be a personal computer, for example.

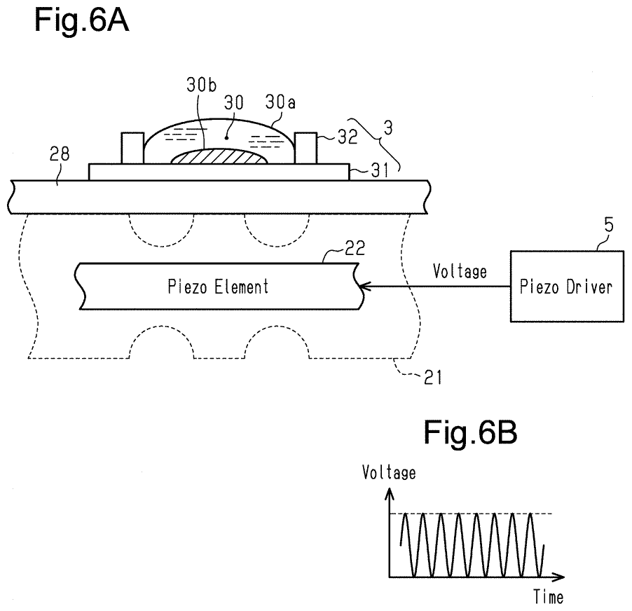

In addition, the stirring system 1 includes a piezo driver 5, which is a driving device for driving a piezo element 22 (see FIG. 6A) of the vibration device 21, and a signal generator 6, which generates a signal for controlling the driving of the piezo driver 5, a laser displacement meter 7, which is a measuring device for measuring the vibration of the stirring device 2, and a lock-in amplifier 8, which processes the measurement signal of the laser displacement meter 7.

Immunostaining is a technique for detecting antigens in a sample using antibodies. Since the recognition of antigens by the antibodies is normally invisible, a color-producing reaction is added to visualize the recognition reaction and detect specific substances. In particular, immunostaining during surgery requires quick determination. To shorten the time, the chemical solution used in immunostaining needs to be stirred efficiently.

To avoid inadvertent contamination, the stirring is performed in a non-contact manner using vibration. A minute amount of liquid has strong surface tension, which needs to be overcome to vibrate the liquid. However, excessive vibration scatters the liquid, which should be avoided. In addition, since the object of vibration is derived from a living body, the object should not be exposed to severe impact or high temperature. The present inventor has found that a Faraday surface wave can be advantageously used to meet these difficult requirements.

To vibrate the vibration device 21 at a predetermined frequency and amplitude, the controller 4 transmits a control signal to the signal generator 6 based on the measurement result received from the laser displacement meter 7 via the lock-in amplifier 8. The signal generator 6 activates the piezo driver 5 to vibrate the piezo element 22 of the vibration device 21 at the predetermined frequency and amplitude, thereby generating a Faraday surface wave, which imparts a significant stirring effect on the surface of the chemical solution on the holder 3.

<Stirring Device 2>

The stirring device 2 shown in FIG. 1 includes the vibration device 21, which is supported by a base 27 including an insulator 29, and a stage 28, which is supported by the vibration device 21. As shown in FIGS. 3 and 4, multiple holders 3 are placed on the stage 28. When held on a holder 3, the chemical solution for immunostaining has a free surface. The holder 3 includes a glass slide 31, which is placed on the stage 28, and a guide 32, which is arranged on the glass slide 31. The chemical solution is surrounded by the guide 32 and held on the glass slide 31 so as to form a free surface. The vibration device 21 applies vertical vibration to the chemical solution. The present embodiment describes an example of immunostaining, which involves difficult requirements, but the use of the stirring device 2 is not limited to immunostaining. For example, the stirring device 2 can also be used to apply vibration to peel off cells cultured in a laboratory dish (a petri dish) filled with a medium.

<Vibration Device 21>

As shown in FIGS. 3 and 4, the vibration device 21 includes a piezo element 22 and honeycomb link members 24. The piezo element 22 is an actuator that can expand and contract in the longitudinal direction (the horizontal direction extending laterally as viewed in FIG. 4). The honeycomb link members 24 amplify and covert the horizontal expansion and contraction into vertical vibration, and transfer the vibration to the stage 28.

<Piezo Element 22>

The piezo element 22 expands in the longitudinal direction when a driving voltage is applied from the piezo driver 5, and contracts when the application of the driving voltage stops. Intermittent application of voltage to the piezo element 22 generates vibration of a desired frequency. Each end of the piezo element 22 in the longitudinal direction is joined to a coupling block 25, which is made of a superhard aluminum alloy and substantially has the shape of a rectangular prism. A semi-cylindrical projection 25a extends from each end of each coupling block 25. The two honeycomb link members 24 of a predetermined length are coupled to the projections 25a of the coupling blocks 25 so as to extend along the piezo element 22 in the longitudinal direction. When the piezo element 22 expands, the coupling blocks 25 stretch the honeycomb link members 24 on both sides of the piezo element 22 in the longitudinal direction. When the application of voltage to the piezo element 22 is stopped, the piezo element 22 returns to its original length, and each honeycomb link member 24 returns to its original shape due to its elasticity.

<Structure of Honeycomb Link Member 24>

In the present embodiment, as shown in FIG. 1, the honeycomb link members 24 are arranged on the base 27 and support the stage 28.

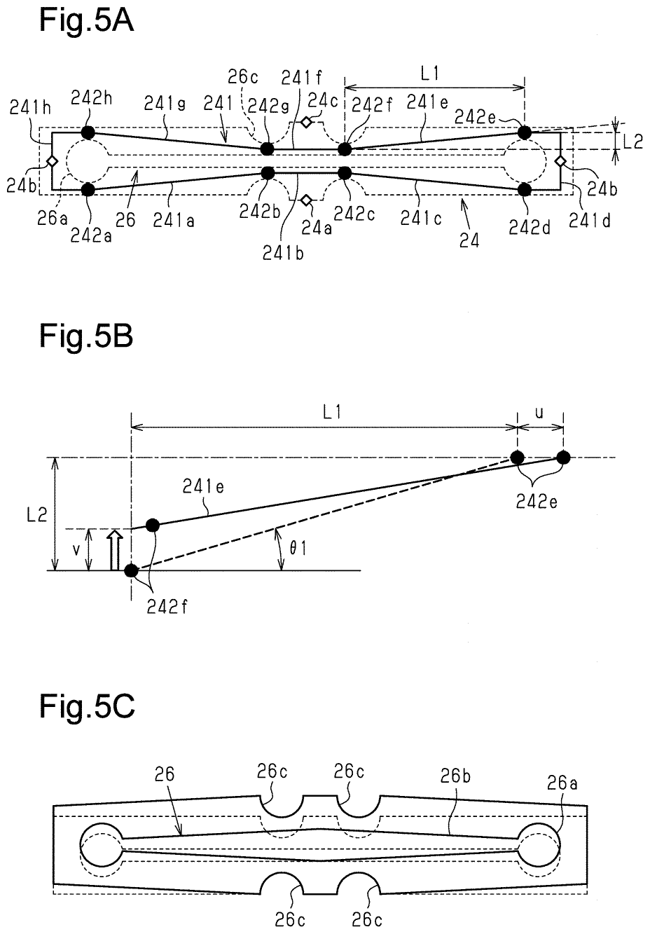

As shown in FIG. 5A, each honeycomb link member 24 is a link mechanism including links and joints and is configured to amplify and convert the horizontal expansion and contraction of the piezo element 22 into vertical vibration of the stage 28.

The honeycomb link member 24 is an elongated plate made of a flexible material, such as a titanium alloy. The honeycomb link member 24 has substantially the same length and width as the piezo element 22. Specifically, the honeycomb link member 24 is longer in the longitudinal dimension than the piezo element 22 by the lengths of the two coupling blocks 25. The coupling blocks 25 at the two ends of the piezo element 22 substantially form free ends of the piezo element 22, and the piezo element 22 can expand and contract (undergo displacement) freely when voltage is applied.

As shown in FIG. 4, holes 26 extend through each honeycomb link member 24 in a direction perpendicular to the longitudinal direction (the thickness direction). The holes 26 include two circular hole sections 26a and an elongated hole section 26b extending between the two circular hole sections 26a. The circular hole sections 26a are arranged in the two longitudinal ends of the honeycomb link member 24. The elongated hole section 26b extends in the longitudinal direction of the honeycomb link member 24 and connects the two circular hole sections 26a. The diameter of the circular hole sections 26a is equal to the diameter of the semi-cylindrical projections 25a of the coupling block 25. Each projection 25a is fitted into the corresponding circular hole section 26a. In addition, two semicircular cutout sections 26c are formed in the central section of each of the side edges extending in the longitudinal direction of the honeycomb link members 24 (the upper and lower side edges as viewed in FIG. 4). A cutout section 26c in one of the side edges is located in the same position in the longitudinal direction of the honeycomb link member 24 as the corresponding cutout section 26c in the other side edge. The diameter of the cutout sections 26c is the same as the diameter of the circular hole sections 26a.

As shown in FIG. 5A, the honeycomb link member 24 includes a fulcrum section 24a, which is at the center of the lower side edge and fixed to the base 27. The honeycomb link member 24 also has two effort sections 24b, which are located on the outer sides of the two ends of the piezo element 22 and configured to be displaced together with the two free ends of the piezo element 22. Further, the honeycomb link member 24 includes a load section 24c, which is located at the center of the upper side edge and fixed to the stage 28. The load section 24c is displaced in the vertical direction, which is perpendicular to the longitudinal direction, by a displacement amount that is greater than the displacement amount of the free end of the piezo element 22 in the longitudinal direction of the piezo element 22.

The honeycomb link member 24 includes hinge sections 242a to 242h each located near the corresponding one of the fulcrum section 24a, the effort sections 24b, and the load section 24c. The hinge sections 242a to 242h are narrow sections and narrower than the other sections due to the presence of the circular hole sections 26a and the cutout sections 26c. The hinge sections 242a to 242h function as elastic hinges or elastic joints. The honeycomb link member 24 also includes links 241a to 241h connected by the hinge sections 242a to 242h. The links 241a to 241h are rigid wide sections that are wider than the hinge sections 242a to 242h.

The fulcrum section 24a is located near the two hinge sections 242b and 242c that correspond in position to the two cutout sections 26c in the lower side edge of the honeycomb link member 24. Specifically, the fulcrum section 24a is located at the midpoint between the two hinge sections 242b and 242c. The load section 24c is located near the two hinge sections 242f and 242g that correspond in position to the two cutout sections 26c in the upper side edge of the honeycomb link member 24. Specifically, the load section 24c is located at the midpoint between the two hinge sections 242f and 242g.

A honeycomb structure generally refers to a structure in which regular hexagonal cells or regular square cells are continuously arranged. However, in the present embodiment, a link mechanism including links 241a to 241h connected to one another to form a single polygonal cell is referred to as the honeycomb link member 24.

The two effort sections 24b are displaced together with the two free ends of the piezo element 22 under predetermined vibration conditions. In response to the movement of the honeycomb link member 24 including the hinge sections 242a to 242h and the links 241a to 241h, the stage 28 coupled to the load section 24c vibrates in the vertical direction, thereby vibrating the glass slide 31 placed on the stage 28. The honeycomb link member 24 may form a link mechanism of a lower pair.

<Controller 4, Piezo Driver 5, Signal Generator 6, Laser Displacement Meter 7, and Lock-In Amplifier 8>

In the present embodiment, DELL Vostro 1520 AGILENT VEE (registered trademark) is used as the controller 4, MATSUSADA Piezo Driver (registered trademark) is used as the piezo driver 5, which is driving device, and AGILENT 20 Hz Function/Arbitrary Wave Generator 33220A (registered trademark) is used as the signal generator 6.

Further, KEYENCE Laser Displacement Meter LC-2400/LC-2440 (registered trademark) is used as the laser displacement meter 7, which is a measuring device, and NF Electronic Instruments Digital Lock-in Amplifier LI5640 (registered trademark) is used as the lock-in amplifier 8, which is a signal processing device.

<Operation of Stirring Device 2>

FIG. 6A is a schematic view showing supply of voltage to the piezo element 22, and FIG. 6B is a diagram illustrating the voltage supplied to the piezo element 22. As shown in FIG. 6A, a voltage is applied to the piezo element 22 from the piezo driver 5. This voltage is generated by the signal generator 6 according to an instruction from the controller 4, and is in the form of a sine wave as shown in FIG. 6B. The frequency and amplitude of this voltage are controlled.

Referring to FIG. 5A, when a voltage is applied, the piezo element 22 expands in the longitudinal direction, thereby applying forces to the two effort sections 24b of the honeycomb link member 24. The forces act in the directions away from each other. This, in turn, applies forces to the hinge sections 242a to 242h in different predetermined directions, displacing the hinge sections 242a to 242h in the respective directions. As a result, the load section 24c located between the two hinge sections 242f and 242g is displaced upward in the vertical direction perpendicular to the longitudinal direction of the honeycomb link member 24. In contrast, the fulcrum section 24a located between the two hinge sections 242b and 242c is fixed to the base 27 and does not move. However, the fulcrum section 24a is displaced vertically downward relative to the effort sections 24b. That is, the honeycomb link member 24 as a whole is lifted vertically upward relative to the fulcrum section 24a fixed to the base 27. This deformation of the honeycomb link member 24 significantly displaces the load section 24c vertically upward.

FIG. 5B shows the link 241e in the upper right side of the honeycomb link member 24. When the link 241d is displaced in the horizontal direction together with the effort section 24b, the hinge section 242e connected to the link 241d is horizontally displaced by a displacement amount u. As for the length between the two hinge sections 242e and 242f connected by the link 241e, the length in the horizontal direction (the longitudinal direction of the honeycomb link member 24) is defined as L1, and the length in the vertical direction (the direction perpendicular to the longitudinal direction of the honeycomb link member 24) is defined as L2. Since the link 241e serving as a connecting element is rigid, the distance (length) between the hinge sections 242e and 242f does not change. As such, the hinge section 242f is vertically displaced by a displacement amount v. Here, the ratio (the displacement magnification ratio) between the displacement amount u in the horizontal direction and the displacement amount v in the vertical direction is expressed by the equation v/u=cot θ1. As such, the displacement magnification ratio can be increased by setting the angle θ1 (the characteristic angle θ1 of the link mechanism) formed by the link 241e and the horizontal direction to a small acute angle (e.g., about 7 degrees). The same applies to the link 241g in the upper left side of the honeycomb link member 24.

As shown in FIG. 5C, a similar displacement occurs also in the lower section of the honeycomb link member 24. However, since the fulcrum section 24a is an immobile point fixed to the base 27, the load section 24c of the honeycomb link member 24 raises the stage 28 in the vertical direction by twice the displacement amount v.

<Generation of Faraday Surface Wave>

In the present disclosure, a Faraday surface wave refers to a surface wave excited by uniform vertical vibration applied to the container.

FIGS. 8A to 8D are schematic views illustrating the mechanism of generation of a Faraday surface wave. As shown in FIG. 8A, when liquid 30 having a free surface 30a is vertically moved upward in vibration, acceleration acts uniformly on the liquid 30. As shown in FIG. 8B, when the liquid 30 is then moved vertically downward, the effect of the gravitational acceleration acting on the liquid 30 is canceled out, and the surface tension creates variations in the height of the surface 30a. As shown in FIG. 8C, when the liquid 30 is again moved vertically upward, the acceleration caused by the vibration acting on the liquid 30 and the gravitational acceleration are combined, causing the surface 30a to temporarily form a horizontal plane. As shown in FIG. 8D, when the liquid 30 is again moved vertically downward, the inertia of the liquid 30 enlarges the waveform.

A Faraday surface wave, also called a Faraday wave or a Faraday ripple, is the phenomenon of parametric resonance that occurs on a free surface of liquid in a container when an external force uniformly vibrates the container. The external force produces a sinusoidal vibration and is thus characterized by frequency and amplitude.

When the frequency is fixed, the amplitude serves as a control parameter. An increase in the amplitude creates a standing wave on the liquid surface. In general, the vibration frequency of the excited wave is often half the vibration frequency applied to the liquid.

When the vibration frequency exceeds the lower threshold, the Faraday surface wave is brought into a state of a standing wave, spatiotemporal modulation, chaos, or a soliton, for example. This facilitates the stirring. In any state, the vibration basically acts in the vertical direction, thereby limiting splashing of the liquid.

In particular, immunostaining uses a minute amount of chemical solution spreading over a large area with a minimum depth, so that the surface tension of the chemical solution exerts a great influence, and convection is less likely to occur in the chemical solution. However, the use of a Faraday surface wave allows the chemical solution spreading over a large area to be stirred by uniform vibration in a desirable manner.

In the stirring system 1 of the present embodiment, the controller 4 controls the frequency and the amplitude of the vibration so that the chemical solutions for immunostaining surrounded by the guides 32 on a large number of glass slides 31 are simultaneously stirred by the Faraday surface wave in a desirable manner.

<Types of Faraday Surface Wave>

By changing at least one of the frequency and amplitude of vibration, which are control parameters, a Faraday surface wave can be in a state of a standing wave, spatiotemporal modulation, a soliton, or chaos, for example.

Standing Wave

A standing wave, also known as a stationary wave, is a wave created by the superposition of two waves moving in opposite directions, each having the same wavelength, cycle (frequency), amplitude, and speed. A standing wave appears to vibrate with its profile fixed in space.

As shown in FIGS. 8A to 8D, the surface 30a with a standing wave includes points N at which the surface does not vibrate and the amplitude is zero. The surface 30a also includes points A where the amplitude and displacement are maximum. The points N are referred to as nodes, and the point A are referred to as anti-nodes.

Recent experiments have started to reveal that a Faraday surface wave, which is the phenomenon of resonance caused by vertical vibration of a liquid surface, can be excited to form various patterns, such as straight lines, squares, hexagons, triangles, and quasi-periodic structures, depending on various conditions. Due to its stable waveform, a standing wave is less efficient in stirring a liquid as compared to other types of Faraday surface waves. However, a standing wave has the advantage of being less prone to splashing or exerting an excessive impact to the object of stirring.

Spatiotemporal Modulation

A wave in a state of spatiotemporal modulation refers to a Faraday surface wave in which the spatial position of a standing wave pattern changes with time.

This traveling in space allows the wave in a state of spatiotemporal modulation to stir the liquid more efficiently than a standing wave.

Soliton

A soliton is a stable, pulse-like solitary wave that is governed by a nonlinear equation and satisfies the following conditions.

(1) A solitary wave propagates preserving its shape and speed. This is a phenomenon corresponding to the law of inertia of particles.

(2) After the waves satisfying Condition (1) collide with each other, these waves propagate in a stable manner. The number of waves involved in collision may be more than two. That is, the individuality of each wave is maintained, and the momentum remains unchanged before and after a collision.

A solitary wave satisfying these two conditions has properties of particles. Solitary waves remain unchanged after colliding with one another, resulting in complex movements that efficiently stir the liquid. A Faraday surface wave does not always become a soliton.

Chaos

Chaos is a phenomenon in which a wave appears random at first look but actually has complex patterns that are unpredictable due to numerical errors. The term unpredictable used herein does not imply random. The phenomenon is generally parametric and governed by deterministic laws. However, since the solution cannot be obtained by integration, a numerical analysis is required to determine the future (and the past) behavior. A Faraday surface wave in a state of such chaos can evenly stir the chemical solution and therefore most efficiently stir the liquid consistently and uniformly.

<Experiment 1: Relationship Between Frequency and Amplitude in Stirring System 1>

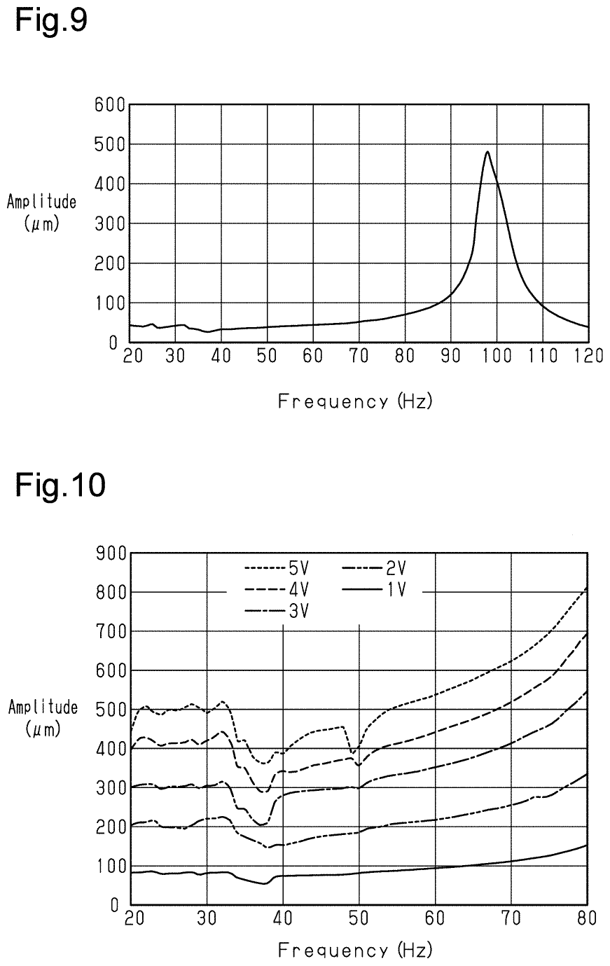

FIG. 9 is a graph showing the relationship between the frequency (Hz) and the amplitude (μm) obtained when a constant voltage (500 mV) was applied to the piezo element 22 in the stirring system 1. The amplitude (μm) is the total amplitude (the peak to peak amplitude). As shown in FIG. 9, when the frequency was 20 Hz to 80 Hz, the amplitude was approximately 40 to 60 μm. The amplitude increased when the frequency exceeded 80 Hz. The amplitude became 130 μm at 90 Hz and reached a peak of about 490 μm at a frequency near 100 Hz. Then, after the peak, the amplitude decreased to about 100 μm at a frequency of 110 Hz.

Such results were obtained because a frequency slightly below 100 Hz was the inherent resonance point of the vibration device 21. The expansion and contraction of the piezo element 22 was most efficiently converted into vertical vibration at this inherent resonance point, but the efficiency dropped significantly outside the resonance point. The purpose of the stirring system 1 of the present embodiment is not to vibrate efficiently but to intentionally control and reproduce a desired Faraday surface wave. As such, the stirring system 1 excludes the peak around the resonance point and uses the range where the amplitude is stable.

That is, the stirring system 1 of the present embodiment does not use the range of 80 to 110 Hz around the resonance frequency because the amplitude is difficult to control at this range. Although not shown in the graph of FIG. 9, the upper limit is not set to 120 Hz, and the stirring system 1 of the present embodiment may use a range of frequencies exceeding this value, for example, 100 to 200 Hz. The resonance points vary among stirring systems, and each stirring system has its inherent usable frequency range.

<Experiment 2: Relationship Between Frequency and Amplitude at Each Voltage in Stirring System 1>

FIG. 10 is a graph showing the relationship between the frequency (Hz) and the amplitude (μm) obtained when a different constant voltage (1 to 5 V) was applied to the piezo element 22 in the stirring system 1. The voltage was set to 1 V, 2 V, 3 V, 4 V, and 5 V. The frequency range was from 20 Hz to 80 Hz, where the change in amplitude was relatively small.

At each voltage, the amplitude increased as the frequency became closer to the resonance frequency of the stirring system 1. Further, a higher voltage resulted in a higher amplitude. In addition, the higher the voltage, the more pronounced the increase in amplitude caused by resonance.

<Experiment 3: Relationship Between Voltage and Amplitude at Each Frequency in Stirring System 1>

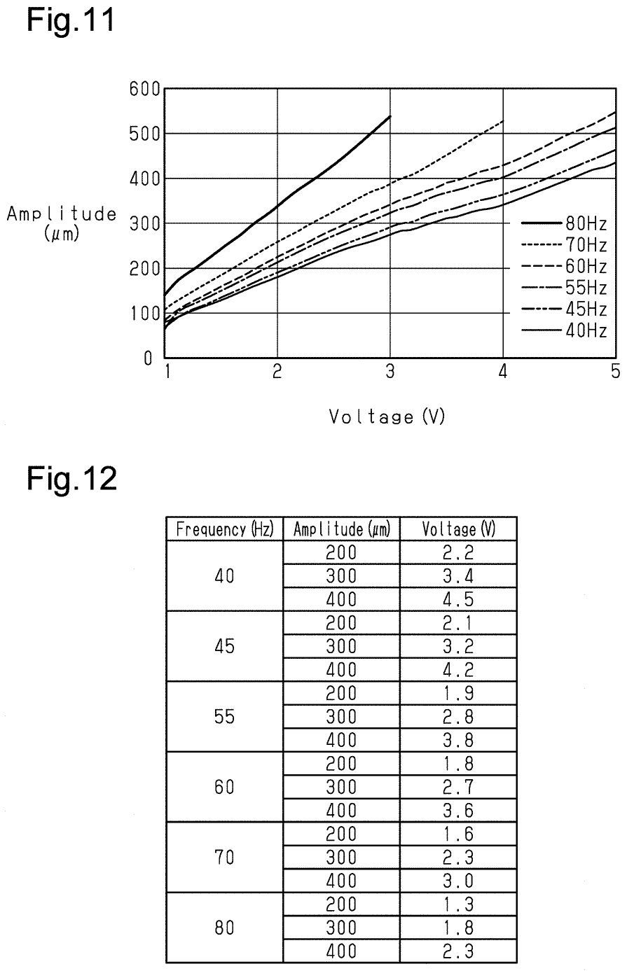

FIG. 11 is a graph showing the relationship between the voltage (V) and the amplitude (μm) in the stirring system 1 at a different constant frequency (40 to 80 Hz). The frequency was set to 40 Hz, 45 Hz, 55 Hz, 60 Hz, 70 Hz, and 80 Hz.

The maximum voltage was set such that an amplitude of greater than or equal to 500 μm or near 500 μm was measured at each frequency. For example, the maximum voltages were 5V for 40 to 60 Hz, 4 V for 70 Hz, and 3 V for 80 Hz. Since the resonance frequency of the stage 28 of the experimental apparatus was 50 Hz, measurement was performed at frequencies near the resonance frequency, 45 Hz and 55 Hz. At each frequency, the amplitude increased linearly with the voltage. It was observed that a higher frequency provided a higher amplitude at the same voltage.

<Experiment 4: Voltage (V) for Obtaining Target Amplitude (μm) at Each Frequency (Hz)>

FIG. 12 is a table showing voltages (V) that provide target amplitudes (μm) at each frequency (Hz). A Faraday surface wave is a parametric resonance based on the parameters of frequency (Hz) and amplitude (μm) of vertical vibration. As such, in order to control the Faraday surface wave, a voltage for obtaining a desired amplitude at each frequency (40 to 80 Hz) was determined based on the results of Experiments 1 to 3. Taking account of the resonance frequency of the stage 28 of the stirring system 1 described above, the frequency was set to 40 Hz, 45 Hz, 55 Hz, 60 Hz, 70 Hz, and 80 Hz.

In the stirring system 1, the controller 4 transmits a signal through the signal generator 6 to the piezo driver 5 to drive the piezo element 22. At this time, the controller 4 determines the frequency (Hz) of the signal and selects a voltage (V) corresponding to a desired amplitude (μm) as the signal voltage (V), thereby controlling the vibration device 21. A desired Faraday surface wave is thus generated on the free surface of the chemical solution held on the holder 3.

For example, when it is known that a standing wave is generated at a frequency of 60 Hz and an amplitude of 300 μm, a voltage of 2.7 V is applied to generate a standing wave.

<Relationship Between Frequency (Hz), Amplitude (μm), and Type of Faraday Surface Wave>

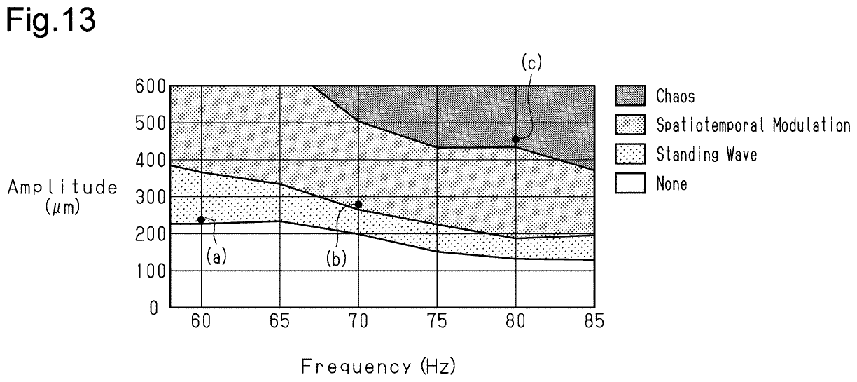

FIG. 13 is a graph showing the relationship between the frequency (Hz), the amplitude (μm), and the type (state) of a Faraday surface wave in the stirring system 1 of the present embodiment.

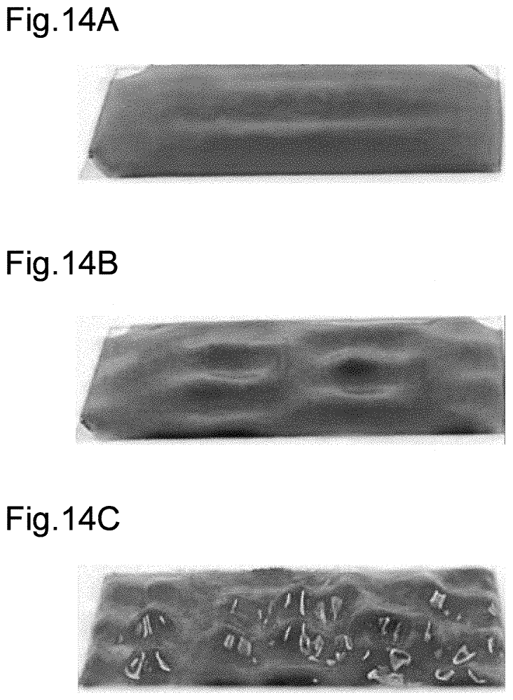

For example, as shown in FIG. 13, when a voltage is applied to the piezo element 22 such that the frequency is 60 Hz and the amplitude is about 240 μm, the coordinate position (a) is within the region of standing wave. This generates a Faraday surface wave that is in a state of a standing wave as shown in FIG. 14A. When a voltage is applied to the piezo element 22 such that the frequency is 70 Hz and the amplitude is about 270 μm, the coordinate position (b) is within the region of spatiotemporal modulation as shown in FIG. 13. This generates a Faraday surface wave that is in a state of spatiotemporal modulation as shown in FIG. 14B. Further, when a voltage is applied to the piezo element 22 such that the frequency is 80 Hz and the amplitude is about 460 μm, the coordinate position (c) is within the region of chaos as shown in FIG. 13. This generates a Faraday surface wave that is in a state of chaos as shown in FIG. 14C.

As such, to generate a standing wave, a frequency and an amplitude are selected from the region of standing wave in the graph of FIG. 13, and a voltage signal is generated that achieves the selected frequency and amplitude.

Although a soliton is not described here, adjusting the frequency and amplitude can generate a Faraday surface wave that is in a state of a soliton. The design of various parts of the stirring system 1, such as the shape of the guide 32, affects the state of the Faraday surface wave. However, under the same conditions, the same state can be reproduced at the same frequency and the amplitude.

<Stirring Process>

As shown in FIG. 4, a sample 30b is placed on the glass slide 31 and surrounded by the guide 32. In this state, a chemical solution 30 is dropped within the guide 32. The chemical solution 30 held within the guide 32 has a free surface 30a. The guide 32 is drawn on the glass slide 31 with a water repellent pen for immunostaining, such as a Dako Pen (registered trademark of DAKO). Then, the glass slide 31 holding the chemical solution 30 is placed and fixed on the stage 28 and vibrated by the vibration device 21. As a result, a Faraday surface wave is generated on the free surface 30a of the chemical solution 30, thereby stirring the chemical solution 30. The glass slide 31 is fixed to the stage 28 using a physical fixing jig, adhesion, negative pressure, or other means.

The stirring may be continuous. For example, a Faraday surface wave that is in a fixed state, such as the state of a standing wave, may be maintained for a predetermined time. Alternatively, the stirring may be performed intermittently by alternating the generation of a Faraday surface wave and a stationary state. Further, the Faraday surface wave may be changed among states (types) of a standing wave, spatiotemporal modulation, chaos, and a soliton. This may increase the efficiency of stirring. The frequency and/or amplitude may be changed without changing the type of wave. The appropriate amplitude depends on the depth of the chemical solution. For example, for the immunostaining of the present embodiment, a range of 200 to 400 μm is desirable, and an amplitude higher than this may scatter the chemical solution. An appropriate amplitude is selected according to the object of stirring. In addition, the frequency is also selected according to the conditions of the object of stirring, such as the depth of the chemical solution 30.

<Conclusion>

As described above, controlling the frequency and amplitude allows for generation of a desired Faraday surface wave. The Faraday surface wave can efficiently stir a minute amount of liquid spreading over a relatively large area, such as a chemical solution used for immunostaining.

The present embodiment has the following advantages.

(1) A minute amount of chemical solution can be efficiently stirred in a short time.

(2) Even when a minute amount of chemical solution has an extremely small depth, a Faraday surface wave can stir the chemical solution overcoming the surface tension in a non-contact manner. Such non-contact stirring limits inadvertent contamination.

(3) Faraday surface waves basically move in the vertical direction. As such, a Faraday surface wave of a suitable amplitude efficiently stirs a minute amount of chemical solution in a short time without scattering the solution.

(4) If ultrasound is used for stirring, cavitation may heat or damage the object of stirring. In contrast, the use of a Faraday surface wave limits damage of a fragile sample, such as living organism.

(5) No electric or magnetic field is involved, avoiding any problem with a sample that would otherwise be affected by an electric or magnetic field.

(6) A desired Faraday surface wave can be generated by controlling the frequency and amplitude. As such, according to the target sample, a Faraday surface wave is generated that is in a state of a standing wave, spatiotemporal modulation, chaos, or a soliton.

(7) By switching between a state where a Faraday surface wave is generated and a stationary state without a Faraday surface wave, the stirring is appropriately controlled to protect the sample or to achieve other purposes.

(8) Changing the type of the generated Faraday surface wave allows for the selection of the most efficient stirring for the sample.

(9) The stage 28 can accommodate a large number of glass slides 32 and thus stir a large number of samples simultaneously. Accordingly, a large number of samples can be tested in a short time in intraoperative rapid pathological diagnosis.

(10) The stirring method of the present embodiment can easily peel off cells cultured in a laboratory dish having a large area without damaging the cells.

(11) The controller 4 sets conditions necessary for generating a desired Faraday surface wave, and transmits the setting to the signal generator 6. The signal generator 6 generates a control signal according to the setting and outputs the control signal to the piezo driver 5. The piezo driver 5 drives the piezo element 22 based on the control signal. The vibration applied to the chemical solution is thus controlled easily.

(12) The laser displacement meter 7 monitors the vertical vibration of the stage 28, and the monitoring result is sent as feedback to the controller 4 via the lock-in amplifier 8. This allows for accurate control of the frequency and amplitude of the stage 28. The control signal may be calibrated based on this feedback, eliminating the need for sending feedback for accurate control.

(13) The vibration is generated by the piezo element 22 having a laminated structure, achieving precise control with high responsiveness. The piezo element 22 can vibrate the large stage 28 with a strong driving force. As a result, the compact vibration device 21 is able to stir the chemical solutions on a large number of glass slides 31 on the stage 28 and to vibrate a sample in a large laboratory dish.

(14) Although the displacement of the piezo element 22 is small, the honeycomb link members 24 amplify and convert this displacement into large vibration.

The above-described embodiment may be modified as follows. The above-described embodiment and the following modifications can be combined as long as the combined modifications remain technically consistent with each other.

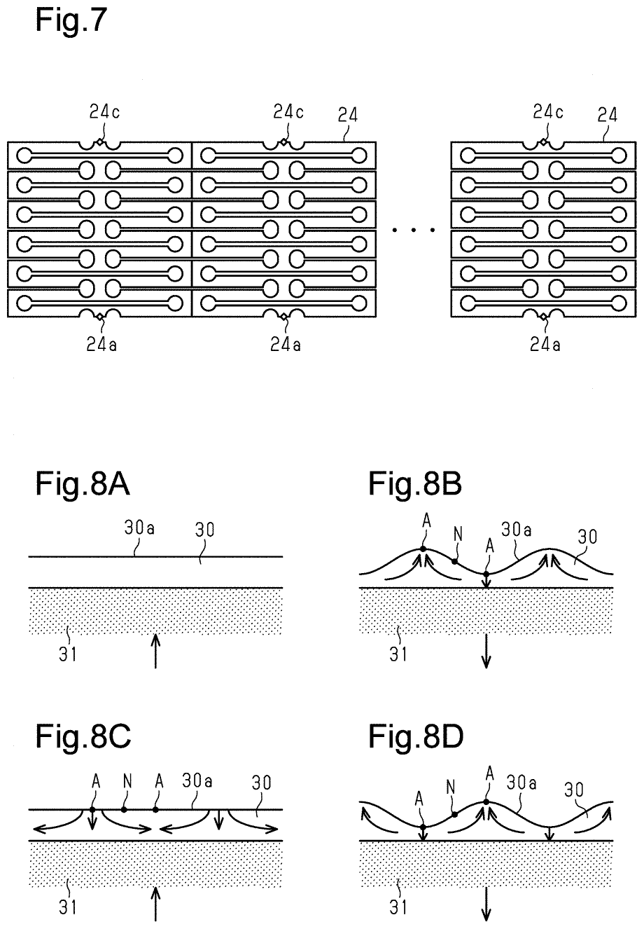

The honeycomb link member 24 is not limited to the configuration of the embodiment, and may have a different configuration. FIG. 7 shows honeycomb link members 24 of another example. As shown in FIG. 7, the honeycomb link members 24 are layered and integrated by connecting the load section 24c of a honeycomb link member 24 to the fulcrum section 24a of another honeycomb link member 24. Six honeycomb link members 24 are layered in the example shown in FIG. 7. When a voltage is simultaneously applied to the piezo elements 22 placed in the respective honeycomb link members 24, vertical amplitude is obtained that is six times larger than that of the single-layer honeycomb link member 24 of the embodiment described above.

Further, as shown in FIG. 7, groups of layered honeycomb link members 24 may be arranged in the horizontal direction and connected to one another. This allows the stage 28 to be larger and to stir a chemical solution spreading over a large area or stir a large number of samples.

The hinge sections 242a to 242h are narrow sections and narrower than other sections due to the presence of the circular hole sections 26a and the cutout sections 26c. The hinge sections 242a to 242h may have any shape. For example, each honeycomb link member 24 may have rectangular cutout sections as shown in FIG. 1.

In the embodiment, each honeycomb link member 24 has eight hinge sections 242a to 242h and eight links 241a to 241h. However, the number and arrangement of the hinge sections and links may be set freely as long as the expansion and contraction of the piezo element 22 are amplified and converted into vertical vibration.

The embodiment stirs the chemical solution on the holder 3 placed on the stage 28. However, the stage 28 may be omitted, and the holder 3 may be placed directly on the load sections 24c of the honeycomb link members 24.

The expandable actuator is not limited to the piezo element.

The vibration device 21 of the embodiment includes the honeycomb link members 24. However, the present discloser is not limited to this, and any mechanism, such as a voice coil, may be used that can generate a Faraday surface wave.

In the embodiment, the stirring of the chemical solution used for immunostaining is described as an example, but the object of stirring is not limited to this. For example, a Faraday surface wave may be used to dissolve powder in a liquid or to peel off an object by vibration. A Faraday surface wave may also be used to mix powders.

The controller 4 may be processing circuitry including: 1) one or more processors that operate according to a computer program (software); 2) one or more dedicated hardware circuits (application specific integrated circuits: ASIC) that execute at least part of various processes, or 3) a combination thereof. The processor includes a CPU and memories such as a RAM and a ROM. The memories store program codes or commands configured to cause the CPU to execute processes. The memories, or computer readable media, include any type of media that are accessible by general-purpose computers and dedicated computers.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A stirring method comprising:
holding liquid having a free surface with a holder;
applying vertical vibration to the holder with a vibration device; and
generating a Faraday surface wave on the free surface of the liquid to stir the liquid by controlling at least one of an amplitude and a frequency of the vertical vibration.

2. The stirring method according to claim 1, further comprising controlling at least one of the amplitude and the frequency of the vertical vibration such that the Faraday surface wave is in a state of a standing wave, spatiotemporal modulation, chaos, or a soliton.

3. The stirring method according to claim 1, further comprising controlling at least one of the amplitude and the frequency of the vertical vibration such that the Faraday surface wave changes from one of states of a standing wave, spatiotemporal modulation, a soliton, and chaos to another one of the states.

4. The stirring method according to claim 1, further comprising intermittently generating the Faraday surface wave.

5. The stirring method according to claim 1, further comprising changing at least one of the amplitude and the frequency of the vertical vibration during stirring of the liquid.

6. The stirring method according to claim 1, further comprising:
expanding and contracting an actuator of the vibration device in a horizontal direction, wherein the actuator has a free end configured to be displaced in the horizontal direction; and
converting the expansion and contraction in the horizontal direction into the vertical vibration with a link mechanism of the vibration device, wherein the link mechanism includes an effort section, which is configured to be displaced in the horizontal direction together with the free end of the actuator, and a load section, which is configured to be displaced in a vertical direction together with the holder, and an amount of displacement of the load section is greater than an amount of displacement of the effort section.

7. The stirring method according to claim 1, further comprising setting the frequency of the vertical vibration to a frequency that differs from a resonance frequency of the vibration device.

8. The stirring method according to claim 7, further comprising setting the frequency of the vertical vibration to 40 to 200 Hz.

9. The stirring method according to claim 1, wherein the liquid is a chemical solution for immunostaining.

10. A stirring system comprising:
a vibration device configured to generate vertical vibration;
a holder configured to hold liquid having a free surface and receive the vertical vibration from the vibration device; and
processing circuitry configured to generate a Faraday surface wave on the free surface of the liquid to stir the liquid by controlling at least one of an amplitude and a frequency of the vertical vibration.

11. The stirring system according to claim 10, wherein
the vibration device includes
an actuator configured to expand and contract in a horizontal direction, wherein the actuator has a free end configured to be displaced in the horizontal direction, and
a link mechanism configured to convert the expansion and contraction in the horizontal direction into the vertical vibration,
the link mechanism includes
an effort section configured to be displaced in the horizontal direction together with the free end of the actuator, and
a load section configured to be displaced in a vertical direction together with the holder, and
an amount of displacement of the load section is greater than an amount of displacement of the effort section.

12. The stirring system according to claim 11, wherein
the link mechanism includes
a first hinge section that is located near the effort section and configured to be displaced in the horizontal direction together with the effort section,
a second hinge section that is located near the load section and configured to be displaced in the vertical direction together with the load section, and
a rigid link extending between the first hinge section and the second hinge section.
